(19) United States
(12) Patent Application Publication
(10) Pub. No.: US 2024/0101356 A1
(43) Pub. Date: Mar. 28, 2024

(54) APPARATUS FOR RETURNING A MULTIUSE CONTAINER AND OPERATION METHOD THEREOF

(71) Applicant: OYSTER ABLE CO., LTD., Seoul (KR)

(72) Inventors: Tae Goan BAE, Seoul (KR); ERIC GONZALEZ MICHEL, Seoul (KR); Kang Min LEE, Seoul (KR)

(21) Appl. No.: 17/935,041

(22) Filed: Sep. 23, 2022

(30) Foreign Application Priority Data
Sep. 22, 2022 (KR) 10-2022-0120380

(51) Int. Cl. B65G 43/00

(52) U.S. Cl. CPC B65G 43/00; B65G 2201/0235; B65G 2203/044

(57) ABSTRACT

There is provided with apparatus for returning a multiuse container and operation method thereof. According to the present invention, container return apparatus comprises an insertion part for inserting a container thereinto, a checking part for sensing the container inserted to detect a state of the container, a controller for ejecting the container in a predetermined direction based on the detected state of the container, and a stacking part for stacking the ejected container on top of another ejected container.

### CROSS REFERENCE TO RELATED APPLICATIONS

The present application claims the benefit of Korean Patent Application No. 10-2022-0120380 filed in the Korean Intellectual Property Office on Sep. 22, 2022, the entire contents of which are incorporated herein by reference.

### FIELD OF THE INVENTION

The present invention relates to a multi-use container return apparatus as an unmanned multi-use cup return machine and a method for operating the same, and more specifically, to an unmanned container return apparatus and a method for operating the same that is capable of allowing a consumer to automatically return his or her used container at a drink or food store thereto.

### BACKGROUND OF THE RELATED ART

As social interests in environments become high, recently, various rules for reducing the use of single-use containers have been suggested. Further, people start participating in social movements for suppressing the use of the single-use containers. For example, they use their thermos, instead of single-use cups, when they visit a store such as a coffee shop, and the like.

However, a number of single-use containers are still used to package or store food or drinks therein at many of restaurants and coffee shops, and even if it is desired that multi-use or single-use containers are returned and collected at the restaurants and coffee shops, a return system for multi-use or single-use containers is not installed at the restaurants and coffee shops, which causes the return rate of the multi-use or single-use containers to become low. Further, if the multi-use or single-use containers are thrown away, without being collected, they may cause environmental pollution.

If a personal multi-use container such as a thermos or a personal single-use container is used, a customer has a given percentage off, and otherwise, an event in which a multi-use or single-use container as a free item is given to a customer is provided. Until now, however, the return and collection of the multi-use or single-use containers used are not generally achieved because of the above-mentioned various reasons.

In specific, business owners have many difficulties in collecting multi-use or single-use containers, detecting bad containers, and washing the containers, which requires high labor costs and lot of time.

### SUMMARY OF THE INVENTION

Accordingly, the present invention has been made in view of the above-mentioned problems occurring in the related art, and it is an object of the present invention to provide a container return apparatus and a method for operating the same that is capable of allowing a customer to return his or her used multi-use container through an unmanned automatic system.

It is another object of the present invention to provide a container return apparatus and a method for operating the same that is capable of automatically recognizing a container returned by means of a sensor and automatically stacking the recognized container to a right position of a stacking part.

It is yet another object of the present invention to provide a container return apparatus and a method for operating the same that is capable of automatically changing a stacking member in which a multi-use container is stackingly placed in position, based on a container stacking level of the stacking member.

It is still another object of the present invention to provide a container return apparatus and a method for operating the same that is capable of easily loading and unloading a stacking part thereon and therefrom when multi-use containers returned are collected.

To accomplish the above-mentioned objects, according to the present invention, there is provided a container return apparatus including: an insertion part for inserting a container thereinto; a checking part for sensing the container inserted to detect a state of the container; a controller for ejecting the container in a predetermined direction based on the detected state of the container; and a stacking part for stacking the ejected container on top of another ejected container.

To accomplish the above-mentioned objects, according to the present invention, there is provided a method for operating a container return apparatus, which is executed by a computing device, comprising the steps of: slidably moving a door in a first direction to open an insertion part, if a container inserted through the insertion part is sensed, slidably moving the door in a second direction in response to the sensed result for the container to thus close the insertion part, detecting a state of the container, and if it is detected that the container is at a first state, operating a motor to allow the container to be ejected in a predetermined direction and located stackingly in a stacking part.

### BRIEF DESCRIPTION OF THE DRAWINGS

FIG. 1 is a front view showing a container return apparatus according to the present invention;

FIG. 2 is a perspective and front view showing an insertion part of the container return apparatus according to the present invention;

FIG. 3 is a perspective view showing a first sensor for sensing a user's hand and its operation in the container return apparatus according to the present invention;

FIG. 4 is a front view showing a method for closing a door after the inserted container has been sensed in the container return apparatus according to the present invention;

FIG. 5 is a perspective view showing a method for sensing an operation of a first motor to prevent a safety accident from happening when the door is closed in the container return apparatus according to the present invention;

FIG. 6 is a side view showing a configuration of a checking part of the container return apparatus according to the present invention;

FIG. 7 is a side view showing a method for operating a motor to locate the container stackingly in a stacking part if the container is at a normal state in the container return apparatus according to the present invention;

FIG. 8 is a perspective view showing configurations of the stacking part and a loading part of the container return apparatus according to the present invention;

FIG. 9 is a perspective view showing the underside of the stacking part of FIG. 8;

FIG. 10 is a sectional view showing the loading part of FIG. 8;

FIG. 11 is a perspective and sectional view showing fixing members for securing the loading part to a bottom plate in the container return apparatus according to the present invention;

FIG. 12 is a perspective view showing a method for sliding out the loading part from the container return apparatus according to the present invention so as to collect the containers stacking in the stacking part;

FIG. 13 is a flowchart showing a method for operating a container return apparatus according to the present invention; and

FIG. 14 is an exemplary view showing a method for collecting the multi-use containers stacking in the container return apparatus according to the present invention, through a remote server.

FIG. 15 is a block diagram showing an exemplary hardware configuration of a computing device, in which embodiments according to present invention may be implemented.

### DETAILED DESCRIPTION OF THE EMBODIMENTS

Hereinafter, an explanation of embodiments of the present invention will be given in detail with reference to the attached drawings. Objects, characteristics and advantages of the present invention will be more clearly understood from the detailed description as will be described below and the attached drawings. Before the present invention is disclosed and described, it is to be understood that the disclosed embodiments are merely exemplary of the invention, which can be embodied in various forms. Those skilled in the art will envision many other possible variations within the scope of the present invention.

In the description, the corresponding parts in the embodiments of the present invention are indicated by corresponding reference numerals and the repeated explanation on the corresponding parts will be avoided. If it is determined that the detailed explanation on the well known technology related to the present invention makes the scope of the present invention not clear, the explanation will be avoided for the brevity of the description.

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification. Terms used in this application are used to only describe specific exemplary embodiments and are not intended to restrict the present invention. An expression referencing a singular value additionally refers to a corresponding expression of the plural number, unless explicitly limited otherwise by the context.

Terms, such as the first, the second, A, B, (a), and (b) may be used to describe various elements, but the elements should not be restricted by the terms. The terms are used to only distinguish one element from the other element. When it is said that one element is described as being “connected” or “coupled” to the other element, one element may be directly connected or coupled to the other element, but it should be understood that another element may be present between the two elements.

In the description, a multi-use container may be a multi-use cup, but it is not limited thereto. For example, the multi-use container may be a multi-use dish or bowl.

In the description, further, it is assumed that the container returned by a container return apparatus according to the present invention is a multi-use container, but it is not limited necessarily thereto. For example, according to a specific embodiment of the present invention, the container return apparatus may be configured to return a single-use container or both of a single-use container and a multi-use container.

Hereinafter, an explanation of embodiments of the present invention will be given in detail with reference to the attached drawings.

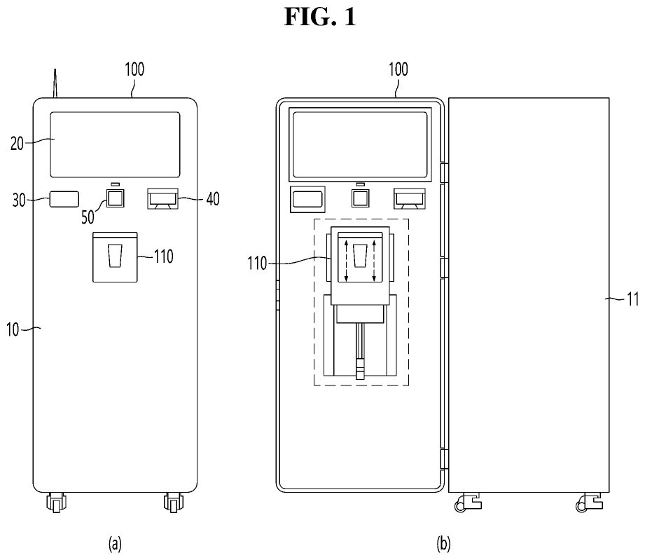

FIG. 1 is a front view showing a container return apparatus according to the present invention. Referring to FIG. 1, a front frame 10 of a container return apparatus 100 according to the present invention is shown. The front frame 10 includes a display part 20, an RFID reader 30, a cash discharger 40, a user recognizing part 50, and an insertion part 110. FIG. 1(a) is a front view of the front frame 10, and FIG. 1(b) is a back view of the front frame 10.

The display part 20 serves to display the information and user interface related to the operations of the container return apparatus 100. The display part 20 may be one of a liquid crystal display (LCD), an organic light emitting diodes (OLEDs) display, and other display devices.

The RFID reader 30 serves to recognize an RFID tag or an RFID signal received from an RFID device. Specific configurations and functions of the RFID reader 30 are well known in the art, and accordingly, an explanation for them will be avoided.

The cash discharger 40 serves to discharge the cash to be paid or returned to a user. For example, the cash may be provided as a reward for the user's return of the used container.

The user recognizing part 50 serves to recognize various pieces of information related to the user. The user recognizing part 50 includes a sensor for sensing an approach of an object, barcodes, QR codes, and the like.

For example, if the user recognizing part 50 recognizes the user's approach by means of the sensor, the door of the insertion part 110 is open to allow a multi-use or single-use container to be at an insertable state. In this case, the display part 20 displays a state where the multi-use or single-use container is allowed to be now inserted and thus induces the user to insert the multi-use or single-use container into the insertion part 110.

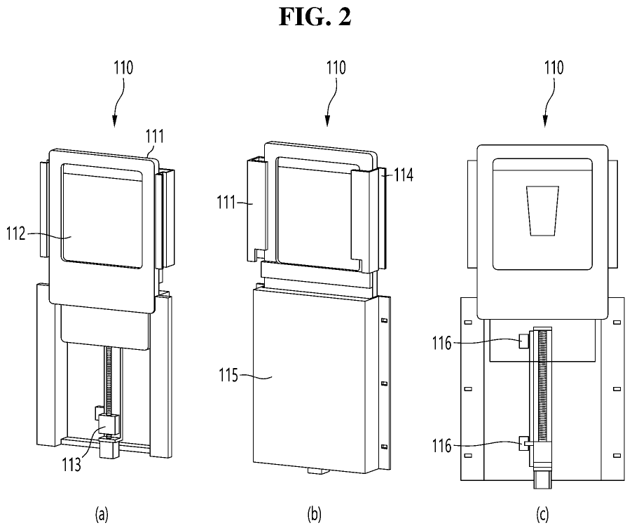

The insertion part 110 serves as a part into which the multi-use or single-use container is inserted. The insertion part 110 has the openable door attached thereto. Specific operations and functions of the insertion part 110 will be explained in detail with reference to FIG. 2 later.

Further, the container return apparatus 100 according to the present invention includes a communication part (not shown) for performing communication with an external server, and/or a controller (not shown) for controlling the operations thereof.

The communication part is connected to a remote server through wired/wireless networks and performs communication with the remote server so that the container return apparatus 100 can perform container return operations and container data transmission and reception.

In this case, the wired/wireless networks include all types of wired/wireless networks such as local area networks (LANs), wide area networks (WANs), value added networks (VANs), personal area networks (PANs), mobile radio communication networks, or satellite communication networks.

The controller is located inside or outside the container return apparatus 100 and controls the operations of the respective parts of the container return apparatus 100. For example, the controller controls the operations of the insertion part 110, a checking part, a stacking part, and/or a loading part of the container return apparatus 100, as will be discussed later. The controller is a computing device that includes at least one processor, a bus, a communication interface, a memory, and/or a storage.

The controller may be an embedded system that includes at least one power module, a programmable device (e.g., microprocessor), a bus module, a communication interface (e.g., Bluetooth, Wi-Fi, and so on), a memory, and/or a storage.

The controller may execute a firmware program for processing and controlling all hardware parts of the container return apparatus 100.

The controller may be designed to be compatible with a computing device with a general purpose so as to perform hardware control communication, data sharing, and an instruction or command.

FIG. 2 is a perspective and front view showing the insertion part of the container return apparatus according to the present invention. In specific, FIG. 2(a) is a perspective view showing the front of the insertion part 110, FIG. 2(b) is a perspective view showing the back of the insertion part 110, and FIG. 2(c) is a front view showing the insertion part 110. Referring to FIG. 2, the insertion part 110 includes a frame 111, a door 112, a first motor 113, a first sensor 114, and/or a limit sensor 115.

The frame 111 constitutes a portion of an outer appearance of the insertion part 110 and guides movements of the door 112 when the door 112 slides.

The door 112 slides in a first direction or in a second direction opposite to the first direction by means of the first motor 113. When the door 112 completely slides in the first direction (in a downward direction according to an embodiment of the present invention), the insertion part 110 is open, and when the door 112 completely slides in the second direction (in an upward direction according to the embodiment of the present invention), the insertion part 110 is closed.

The first motor 113 provides a driving force for sliding the door 112. According to the embodiment of the present invention, the first motor 113 may be a step motor.

The limit sensor 115 serves to sense a sliding state of the door 112. For example, if the door 112 completely slides in the first direction, the sliding state of the door 112 is sensed by a lower limit sensor of the limit sensor 115, and if the door 112 completely slides in the second direction, the sliding state of the door 112 is sensed by an upper limit sensor of the limit sensor 115. The sensed result of the limit sensor 115 is transmitted to the controller to determine whether the first motor 113 operates or not.

For example, if the door 112 is sensed by the lower limit sensor while the door 112 is sliding in the first direction by means of the first motor 113, the controller stops the operation of the first motor 113 to prevent the door 112 from sliding in the first direction anymore. Otherwise, if the door 112 is sensed by the upper limit sensor while the door 112 is sliding in the second direction by means of the first motor 113, the controller stops the operation of the first motor 113 to prevent the door 112 from sliding in the second direction anymore.

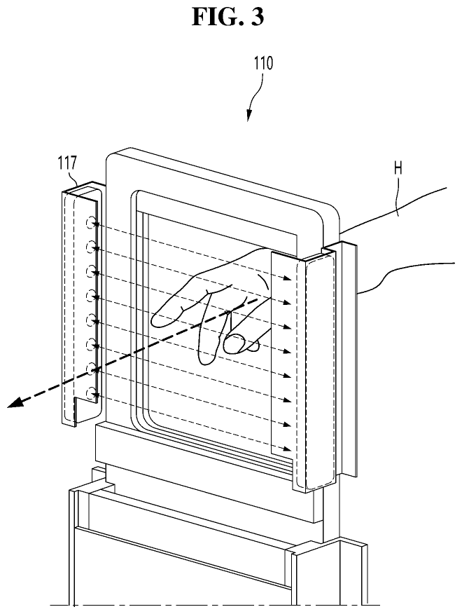

The first sensor 114 serves to sense whether the user's hand enters the insertion part 110 in a state where the door 112 slides in the first direction. According to the embodiment of the present invention, the first sensor 114 may be an area sensor. A specific operation of the first sensor 114 is shown in FIG. 3.

The first sensor 114 detects whether the user's hand H exists in the insertion part 110. If the door 112 of the insertion part 110 is closed in the state where the user's hand H exists in the insertion part 110, the user's hand H may be injured. To prevent such a danger from occurring, the first sensor 114 detects whether the user's hand H exists in the insertion part 110 and allows the door 112 to be closed only when the user's hand H does not exist in the insertion part 110.

Under the configurations as shown in FIGS. 2 and 3, an operation process of the insertion part 110 will be explained below.

If a container return process starts by the user through the user interface displayed on the display part 20 as shown in FIG. 1 so as to return the used container, the first motor 113 operates by the controller to allow the door 112 to slide in the first direction (in the downward direction). If the door 112 is sensed by the lower limit sensor 115 while sliding in the first direction, the controller determines that the door 112 is completely open and then stops the operation of the first motor 113 to prevent the door 112 form sliding in the first direction anymore.

If the used container is returned to the insertion part 110 after the door 112 has been completely open, the first sensor 114 detects whether the user's hand H exists in the insertion part 110.

If it is detected that the user's hand H exists in the insertion part 110, the door 112 is kept open.

If it is detected that the user's hand H does not exist in the insertion part 110, the first motor 113 operates by the controller to allow the door 112 to slide in the second direction (in the upward direction). If the door 112 is sensed by the upper limit sensor 115 while sliding in the second direction, the controller determines that the door 112 is completely closed and then stops the operation of the first motor 113 to prevent the door 112 form sliding in the second direction anymore.

According to the embodiment of the present invention, the first motor 113, the first sensor 114, the limit sensor 115, and/or the controller are connected to one another by means of cables, and the cables are connected or separated to or from one another by means of relay connectors.

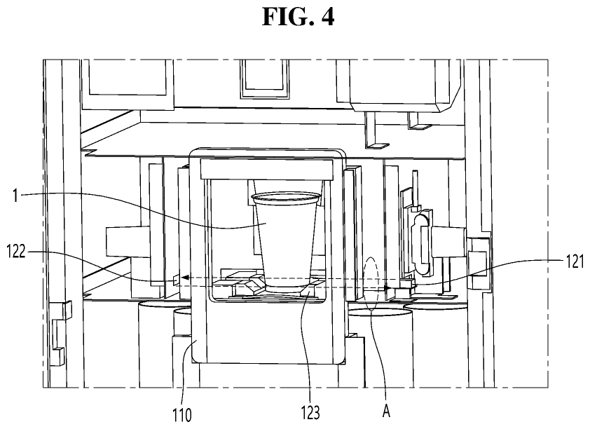

FIG. 4 is a front view showing a method for closing the door after the inserted container has been sensed.

If the container 1 is inserted through the insertion part 110 and mounted on a stand 123, after the insertion part 110 has been open, a second sensor 121 detects whether the container 1 is mounted on the stand 123. According to the embodiment of the present invention, the second sensor 121 may be a photo sensor.

A reflection plate 122 is located on the opposite side to the second sensor 121 and serves to reflect the signal (e.g., optical signal) emitted from the second sensor 121 thereon.

If the container 1 is not mounted on the stand 123, the signal emitted from the second sensor 121 is reflected on the reflection plate 122 and then returned to the second sensor 121 (See a portion A). Contrarily, if the container 1 is mounted on the stand 123, the signal emitted from the second sensor 121 is blocked by the container 1 and thus scattered. Under such a principle, if the signal emitted from the second sensor 121 is not returned to the second sensor 121, it is determined that the container 1 is mounted on the stand 123.

If it is detected that the container 1 is mounted on the stand 123 by means of the second sensor 121, the detected result is transmitted to the controller to control the operation of the first motor 113 so that the insertion part 110 is closed. In specific, the controller operates the first motor 113 to allow the door 112 to slide in the second direction (in the upward direction) in response to the detected result of the second sensor 121. If the door 112 is sensed by the upper limit sensor 115 while sliding in the second direction, the controller determines that the door 112 is completely closed and then stops the operation of the first motor 113 to prevent the door 112 from sliding in the second direction anymore.

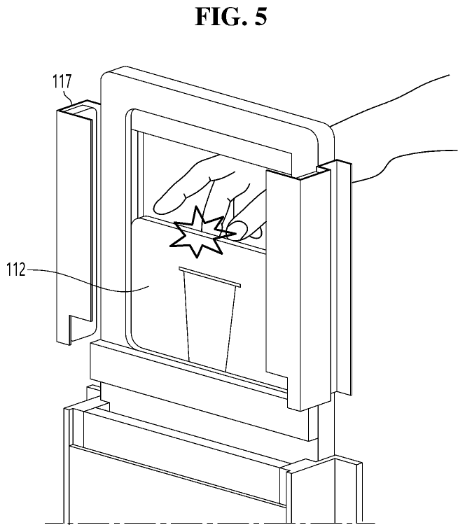

FIG. 5 is a perspective view showing a method for sensing an operation of the first motor to prevent a safety accident from happening when the door is closed.

The controller of the container return apparatus 100 senses an electric current flowing to the first motor 113 while the door 112 is sliding in the second direction (in the upward direction), and if the electric current is over a threshold value, the controller stops the sliding of the door 112 or controls the first motor 113 to allow the door 112 to slide in the first direction (in the downward direction).

This prevents the user's hand from being caught to the door 112 while the door 112 is being closed, thereby protecting the user′ hand from safety accidents. For example, while the door 112 is being closed after the container is returned through the insertion part 110, if the user's hand is not detected by the first sensor 114 because it is located at a blind spot of the first sensor 114, the door 112 may slide in the first direction even if the user's hand still stays in the insertion part 110, so that the user's hand may be caught to the door 112.

To prevent such a safety accident from happening, the controller serves to monitor the electric current flowing to the first motor 113. If the user's hand is caught to the door 112, generally, a larger load is applied to the first motor 113 for operating the door 112, and accordingly, a size of the electric current flowing to the first motor 113 may be increased. Therefore, the controller monitors the electric current flowing to the first motor 113, and if the electric current is over the threshold value, an abnormal state is determined, so that the controller stops sliding of the door 112 or controls the first motor 113 to allow the door 112 to slide in the first direction.

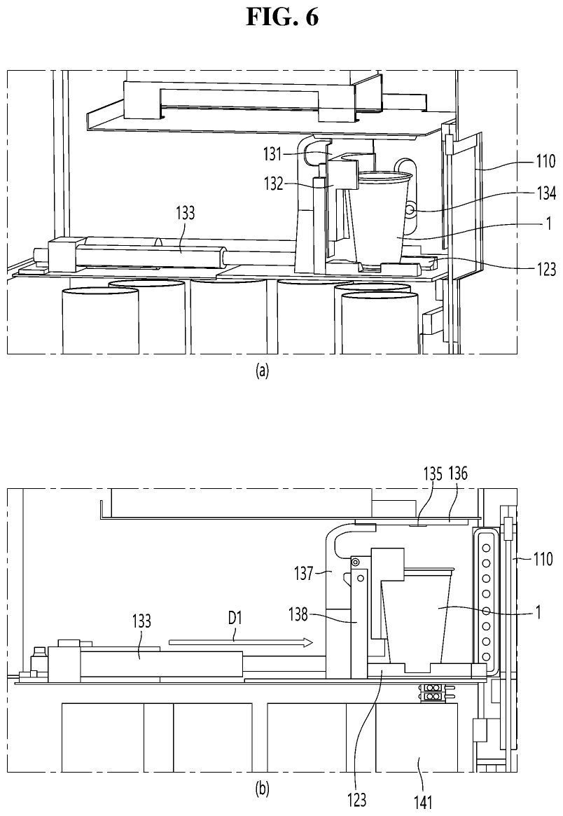

FIG. 6 shows a configuration of the checking part of the container return apparatus according to the present invention. FIG. 6(a) is a side perspective view showing the checking part and FIG. 6(b) is a side view showing the checking part.

According to the embodiment of the present invention, the checking part serves to sense whether the container 1 is inserted and detect a state of the container 1 placed on the stand 123 and includes a camera 134, a lighting device 135, and/or a third sensor 136, together with the second sensor 121 and the stand 123 as discussed in FIG. 4. A blocking plate 131, a container guide 132, and a second motor 133, as shown in FIG. 6, are further included in the checking part. The second motor 133 is coupled to the stand 123 and moves toward the insertion part 110 (that is, in a direction of D1) in a default state thereof.

The camera 134 serves to photograph the container 1 placed on the stand 123 or perform image scanning for the container 1 placed on the stand 123. According to the embodiment of the present invention, the camera 134 may be a webcam. The controller analyzes the image photographed or scanned by the camera 134 and determines whether the container 1 placed on the stand 123 is at a normal or abnormal state.

According to the embodiment of the present invention, the controller includes learning-based container state analysis models, and with the learning-based container state analysis models, the controller analyzes the image photographed or scanned by the camera 134 and thus determines whether the container 1 placed on the stand 123 is at a normal or abnormal state. In this case, the learning-based container state analysis models may be machine learning-based analysis models based on deep learning models such as convolution neural network (CNN), recurrent neural network (RNN), and so on.

The lighting device 135 serves to provide light for photographing or image scanning of the camera 134. According to the embodiment of the present invention, the lighting device 135 may be a light emitting diode (LED) lighting device.

The third sensor 136 serves to measure a container stacking level of a first stacking member 141 of the stacking part 140 as will be discussed later. In this case, the first stacking member 141 is a stacking member that is located under the stand 123 on which the container 1 is placed. In specific, the first stacking member 141 is a stacking member that is located at a position where the container 1 is stackingly placed when the container 1 is ejected down.

According to the embodiment of the present invention, the third sensor 136 may be a laser sensor. The third sensor 136 measures a distance from the uppermost container of the containers stacking in the first stacking member 141 thereto. If a large number of containers stack in the first stacking member 141, the distance from the uppermost container to the third sensor 136, which is measured by the third sensor 136, becomes relatively short. Contrarily, if a small number of containers stack in the first stacking member 141, the distance from the uppermost container to the third sensor 136, which is measured by the third sensor 136, becomes relatively long. Accordingly, the distance between the third sensor 136 and the uppermost container, which is measured by the third sensor 136, corresponds to the container stacking level (that is, the number of stacking containers) of the first stacking member 141.

The controller determines the container stacking level of the first stacking member 141 based on the measured value of the third sensor 136. For example, if the measured value (that is, the distance) of the third sensor 136 is smaller than a predetermined value, the controller determines that the containers are full in the first stacking member 141. In this case, the controller rotates the stacking part 140 to move the first stacking member 141 in which the containers are full to another position, so that another stacking member in which the containers are not full is located under the stand 123.

However, if it is determined that the container 1 placed on the stand 123 is at a normal state (hereinafter, referred to as a first state) after the controller has analyzed the image photographed or scanned by the camera 134, the controller controls the second motor 133 to allow the container 1 to be ejected in a predetermined direction (in a downward direction). Contrarily, if it is determined that the container 1 placed on the stand 123 is at an abnormal state (hereinafter, referred to as a second state), the controller rejects the return of the container 1 and returns the container 1 to the user.

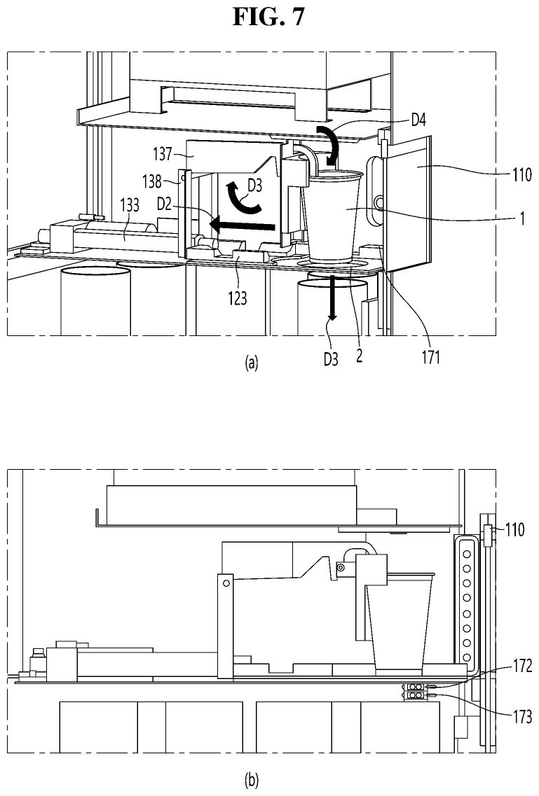

A method for operating the second motor 133 to eject the container 1 in the predetermined direction under the control of the controller will be explained in detail with reference to FIG. 7.

If it is determined that the container 1 is at the first state, the controller controls the second motor 133 to allow the stand 123 to move in a third direction (that is, in a direction of D2). If the stand 123 disappears under the container 1 by the operation of the second motor 133, the container 1 is exposed to an ejection hole 171, passes through the ejection hole 171 by means of gravity, and is ejected in the predetermined direction (in the downward direction, that is, in a direction of D5).

According to the embodiment of the present invention, the container return apparatus 100 further includes a hook member 137 and support rods 138. The hook member 137 serves to limit transverse movements of the container 1 so that when the container 1 is ejected in the predetermined direction (in the direction of D5), it can be accurately ejected to the first stacking member 141. If the hook member 137 does not exist, the container 1 may move to left and right sides when the container 1 is ejected in the predetermined direction, so that the container 1 may collide against the edge periphery of the first stacking member 141, which fails to enter the first stacking member 141 accurately.

An operation of the hook member 137 will be explained in detail with reference to FIG. 7(b).

If the second motor 133 operates to move the stand 123 in the third direction (in the direction of D2), the support rods 138 also move in the third direction (in the direction of D2). In this case, one end of the hook member 137 is fixed to the support rods 138, and the other end of the hook member 137 enters top of the container 1 (that is, moves in a direction of D4) by means of the movements of the support rods 138 to the third direction (in the direction of D2). The hook member 137, which enters top of the container 1, flexibly holds the container 1 and thus limits the transverse movements of the container 1 when the container 1 is ejected in the predetermined direction (in the direction of D5).

Further, the checking part includes a fourth sensor 172 for detecting whether the container 1 is ejected in the predetermined direction (in the direction of D5). Referring to FIG. 7(b), the fourth sensor 172 is located on the underside of the side of the ejection hole 171. According to the embodiment of the present invention, the fourth sensor 172 is a retro-reflective photo sensor that senses the container 1 passing through a sensing track thereof and transmits the sensed result to the controller. The controller counts the number of containers stacking in the stacking part 140 based on the sensed result of the fourth sensor 172. For example, the controller increases the number of containers stacking in the stacking part by one whenever the ejection of the container is sensed by the fourth sensor 172, thereby counting the total number of containers stacking in the stacking part 140.

According to the embodiment of the present invention, the checking part further includes a fifth sensor 173 for measuring the container stacking level of the first stacking member 141. The fifth sensor 173 is a retro-reflective photo sensor, and if the container stacking level of the first stacking member 141 reaches a sensing area of the fifth sensor 173, the fifth sensor 173 senses the container stacking level of the first stacking member 141 and transmits the sensed result to the controller. The stacking part 140 determines the container stacking level of the first stacking member 141 based on the sensed result of the fifth sensor 173. For example, if it is sensed that the container stacking level of the first stacking member 141 reaches the sensing area of the fifth sensor 173, the controller determines that the containers are full in the first stacking member 141 and thus rotates the stacking part 140 to move the first stacking member 141 in which the containers are full to another position so that another stacking member in which the containers are not full is located under the stand 123.

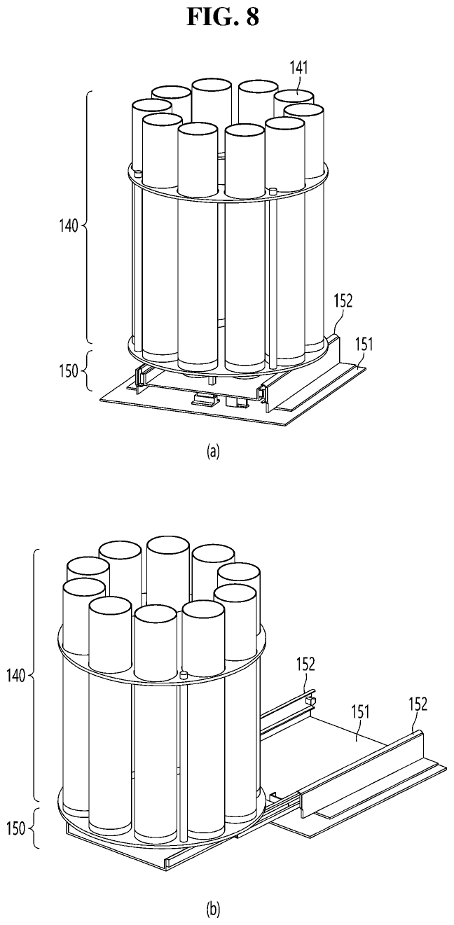

FIG. 8 is a perspective view showing configurations of the stacking part 140 and the loading part 150 of the container return apparatus 100 according to the present invention.

The stacking part 140 includes the plurality of stacking members 141 in which the first stacking member 141 exists, and the loading part 150 serves to load or unload the stacking part 140 thereon or therefrom. The loading part 150 is coupled to a bottom plate 151 by means of guide rails 152 fixed to the bottom plate 151 and slides movably along the guide rails 152.

FIG. 8(a) shows a state where the loading part 150 slides inward toward the bottom plate 151 along the guide rails 152, and FIG. 8(b) shows a state where the loading part 150 slides outward from the bottom plate 151 along the guide rails 152.

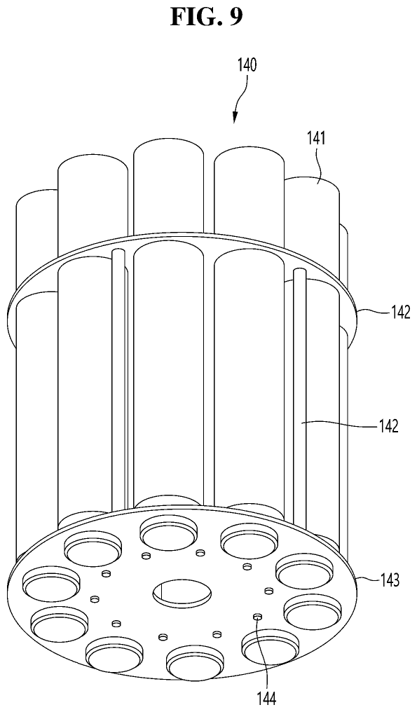

FIG. 9 is a perspective view showing the underside of the stacking part 140 of FIG. 8. The stacking part 140 includes the plurality of stacking members 141 having the same shape as each other, a fixing plate 142, a base plate 143, a plurality of position detection members 144, and/or guide support poles 145.

The plurality of stacking members 141 are defined as stacking spaces separated from one another and serve to stack the containers returned therein.

The fixing plate 142 accommodates the plurality of stacking members 141 in a plurality of holes formed thereon and fixes the upper peripheries of the plurality of stacking members 141 thereto.

The base plate 153 has a plurality of grooves adapted to accommodate the plurality of stacking members 141 thereinto. The base plate 143 serves to fix the lower peripheries of the plurality of stacking members 141 thereto and support the plurality of stacking members 141 against gravity.

The position detection members 144 are spaced apart from one another on the underside of the base plate 143 at an equal angle (that is, 36°) to one another. In this case, the positions of the position detection members 144 correspond to the positions of the plurality of stacking members 141, and for example, the relative positions of the position detection members 144 to the corresponding stacking members 141 are the same as one another.

According to the embodiment of the present invention, the position detection members 144 are dog sensors.

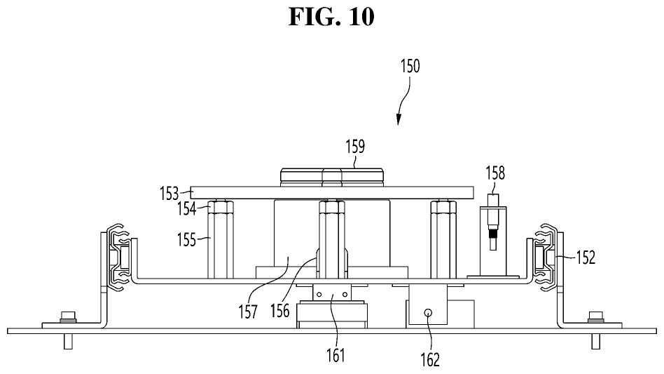

FIG. 10 is a sectional view showing the loading part 150 of FIG. 8. Referring to FIG. 10, the loading part 150 includes a rotation plate 153, ball casters 154, guide support rods 155, a third motor 156, a motor housing 157, and/or a proximity sensor 158.

The rotation plate 153 serves to mount the stacking part 140 thereon. The rotation plate 153 has a guide block 159 located on the center thereof to place the stacking part 140 thereon at a right position and direction.

The ball casters 154 serve to rotatably support the rotation plate 153. The ball casters 154 have rotatable balls located on tops thereof to support the rotation plate 153, while rotating the rotation plate 153.

The guide support rods 155 are coupled to the ball casters 154 to support the rotation plate 153.

The third motor 156 provides a driving force for rotating the rotation plate 153. According to the embodiment of the present invention, the third motor 156 may be an indexing motor.

The motor housing 157 accommodates the third motor 156 therein to protect the third motor 156 from external impacts or pressure.

The proximity sensor 158 is a sensor that detects whether the position detection members 144 are close thereto. If the position detection members 144 are within a given distance from the proximity sensor 158, the proximity sensor 158 transmits the sensed signal to the controller. The controller operates the third motor 156 in response to the sensed signal of the proximity sensor 158.

Hereinafter, an example of such an operation will be explained in detail below.

If it is determined that the containers are full in the first stacking member 141, the controller rotates the stacking part 140 to move the first stacking member 141 in which the containers are full to another position so that another stacking member in which the containers are not full is located under the stand 123.

In this case, the controller operates the third motor 156 of the loading part 150 to rotate the rotation plate 153 and the stacking part 140 mounted on the rotation plate 153, so that the first stacking member 141 in which the containers are full moves to another position and another stacking member in which the containers are not full is located under the stand 123.

When the plurality of stacking members are changed in position through the above-mentioned method, the controller operates the third motor 156 based on the sensed signal of the proximity sensor 158 so as to arrange the plurality of stacking members on accurate positions. For example, when the position detection members 144 are located just over the proximity sensor 158, the controller determines that the plurality of stacking members are arranged on accurate positions and stops the rotation of the stacking part 140 by the third motor 156 at the corresponding positions. Otherwise, if the rotation of the stacking part 140 stops by the third motor 156 in a state where the position detection members 144 are not located just over the proximity sensor 158, the controller determines that the plurality of stacking members are not arranged on accurate positions and operates the third motor 156 again to rotate the stacking part 140 until the position detection members 144 are located just over the proximity sensor 158.

According to the embodiment of the present invention, if it is determined that the containers are full in the first stacking member 141, the controller operates the third motor 156 so that the stacking part 140 rotates by an angle (e.g., 36°) required to move each stacking member 141 to a position of the adjacent stacking member thereto.

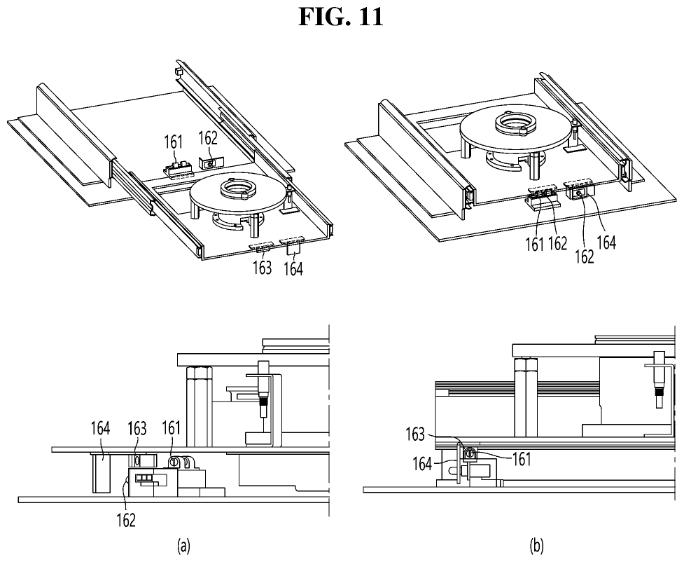

FIG. 11 is a perspective and sectional view showing fixing members for securing the loading part 150 onto the bottom plate 151.

As mentioned above, the loading part 150 is slidably coupled to the bottom plate 151 by means of the guide rails 152. In this case, the bottom plate 151 has fixing members 161 and 162, and the loading part 150 has coupling members 163 and 164 fastened to the fixing members 161 and 162, so that when the loading part 150 completely slides inward, it can be more securely fixed to the bottom plate 151 through the fastening of the coupling members 163 and 164 to the fixing members 161 and 162.

According to the embodiment of the present invention, the fixing member 161 may be a ball catcher and the fixing member 162 may be a door switch.

FIG. 11(a) shows a state where the loading part 150 slides outward from the bottom plate 151, and FIG. 11(b) shows a state where the loading part 150 slides inward toward the bottom plate 151. Referring to FIG. 11(b), when the loading part 150 completely slides inward, the loading part 150 is more securely fixed to the bottom plate 151 through the fastening of the coupling members 163 and 164 to the fixing members 161 and 162.

According to the embodiment of the present invention, if the coupling members 163 and 164 are not fastened to the fixing members 161 and 162, the controller outputs a predetermined warning sound through a speaker. If the coupling members 163 and 164 are not fastened to the fixing members 161 and 162, the controller determines that the loading part 150 is not securely fixed to the bottom plate 151 and outputs the warning sound to notify a manger of the container return apparatus 100 of the present state of the loading part 150. The manager hears the warning sound and completely pushes the loading part 150 toward the bottom plate 151 until the coupling members 163 and 164 are fastened to the fixing members 161 and 162, so that the loading part 150 becomes securely fixed to the bottom plate 151.

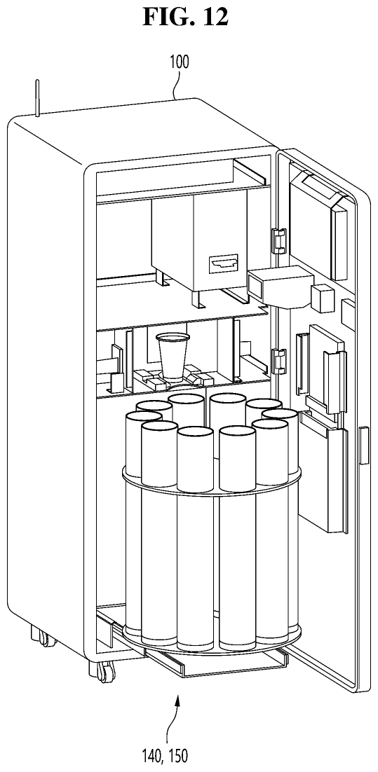

FIG. 12 is a perspective view showing a method for sliding the loading part 150 outward from the container return apparatus 100 so as to collect the containers in the stacking part 140.

Referring to FIG. 12, the front surface of the container return apparatus 100 is open to collect the containers stacking in the stacking part 140, and the loading part 150 slides outward from the container return apparatus 100. In this case, the bottom plate 151 is fixed to the bottom of the container return apparatus 100.

The manager of the container return apparatus 100 demounts the stacking part 140 from the loading part 150 in the state where the loading part 150 slides out, collects a stack of containers from the stacking part 140, mounts the empty stacking part 140 on the loading part 150, and slides the loading part 150 toward the inside of the container return apparatus 100.

In this case, if the coupling members 163 and 164 of the loading part 150 are not fastened to the fixing members 161 and 162 of the bottom plate 151, the predetermined warning sound is outputted from the speaker to notify the manger of the container return apparatus 100 of the state wherein the coupling members 163 and 164 are not fastened to the fixing members 161 and 162.

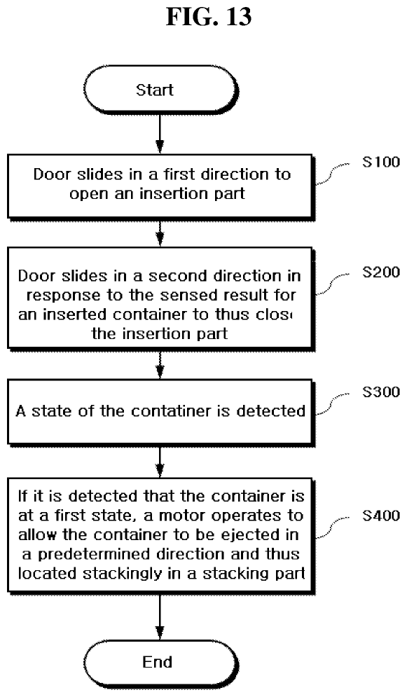

FIG. 13 is a flowchart showing a method for operating a container return apparatus according to the present invention. The method for operating a container return apparatus, as shown in FIG. 13, is executed by the container return apparatus 100 or controller of FIG. 1. Accordingly, if an execution object is not defined in the following steps, it means that the execution object is the container return apparatus 100 or controller.

At step S100, a door slides in a first direction to open an insertion part.

At step S200, if a container inserted through the insertion part is sensed, the door slides in a second direction in response to the sensed result for the container to thus close the insertion part.

At step S300, a state of the container is detected. According to an embodiment of the present invention, the state of the container is detected by photographing or scanning the image of the container through a camera. The detected image is analyzed by using learning-based container state analysis models, and based on the analyzed result, it is determined whether the container is at a normal or abnormal state.

At step S400, if the detected container is at a first state (that is, at the normal state), a motor operates to allow the container to be ejected in a predetermined direction and thus located stackingly in a stacking part. As the motor operates, the container is stackingly located in a first stacking member placed under a stand, and if containers are full in the first stacking member, the stacking part rotates to change the respective stacking members in position.

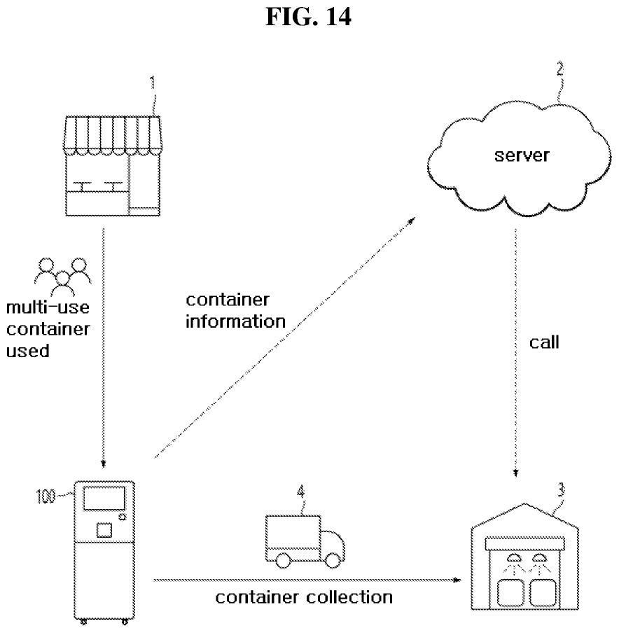

FIG. 14 is an exemplary view showing a method for collecting the multi-use containers stacking in the container return apparatus, through a remote server. Referring to FIG. 14, a container collection system includes a store 1, the container return apparatus 100, a remote server 2, and/or a collection company 3.

The container return apparatus 100 serves to allow customers to return the used multi-use containers provided by the store 1 thereto, which is the container return apparatus 100 as mentioned with reference to FIGS. 1 to 13. When a user purchases food stored in a multi-use container and then eats the food, the used multi-use container is returned to the container return apparatus 100, so that a number of multi-use containers can be returned.

The container return apparatus 100 according to the present invention is connected to the remote server 2 through wired/wireless networks and performs communication with the remote server 2 so that the container return apparatus 100 can perform container return operations and container data transmission and reception.

According to an embodiment of the present invention, the container return apparatus 100 may be a kiosk or sharing device such as a stand type display device that is located at a specific place. If the multi-use or single-use container used is inserted into the container return apparatus 100, the container return apparatus 100 detects whether the multi-use or single-use container is normally inserted, and if normally inserted, the container return apparatus 100 stacks the multi-use or single-use containers sequentially in given stacking spaces. Next, a deposit or reward corresponding to the multi-use or single-use container is calculated and paid to the user.

According to an embodiment of the present invention, the container return apparatus 100 transmits the stacking information of the containers returned thereto to the remote server 2 to allow the remote server 2 to manage and monitor the container return state of the container return apparatus 100.

If the number of containers stacking in the container return apparatus 100 is over a predetermined value, the remote server 2 calls the collection company 3 to collect the containers stacking in the container return apparatus 100, based on the container information received from the container return apparatus 100.

The collection company 3 collects the containers from the container return apparatus 100 in response to the call of the remote server 2 (see a reference numeral 4) and replies the container collection information to the remote server 2. Further, the collection company 3 washes the collected containers and supplies the washed containers to the store 1.

According to an embodiment of the present invention, when the remote server 2 calls the collection company 3 for collecting the stacking containers, it determines one of collection companies 3 according to the priority calculated by a distance between the container return apparatus 100 and each collection company 3 and a service charge of each collection company 3. For example, if a distance between the container return apparatus 100 and the collection company 3 is short, the containers can be quickly collected, and accordingly, the corresponding collection company 3 has high priority. If the service charge of the collection company 3 becomes low, the corresponding collection company 3 has high priority.

According to an embodiment of the present invention, the priority is determined based on a calculation expression wherein the distance between the container return apparatus 100 and the collection company 3 and the service charge of the collection company 3 are weightedly summed. In this case, the calculation expression is the following mathematical expression 1, and through the calculation expression, call scores are determined. The priorities of the collection companies 3 are determined in the order of having high call scores.

Call score=1/[(k1×P)+(k2×Q)] [Mathematical expression 1]

(wherein the k1 represents a predetermined first weighted value, the k2 represents a predetermined second weighted value, the P represents a distance between the container return apparatus 100 and the collection company 3, and the Q represents the service charge of the collection company 3).

According to the mathematical expression 1, if the distance between the container return apparatus 100 and the collection company 3 becomes long, or if the service charge of the collection company 3 becomes high, the call score becomes low, so that a low priority is applied to the corresponding collection company 3.

According to an embodiment of the present invention, the first weighted value or the second weighted value may be different according to the container stacking information of the container return apparatus 100. For example, if the multi-use or single-use containers stack over 80% of the stacking part 140 of the container return apparatus 100, it is assumed that the container stacking information, “full” is transmitted, and if the multi-use or single-use containers stack over 95% of the stacking part 140 of the container return apparatus 100, it is assumed that the container stacking information, “urgent” is transmitted.

In this case, if the remote server 2 receives the container stacking information, “full”, the remote server 2 determines that it is necessary to collect the containers but the collection is not urgent. Accordingly, the remote server 2 applies a general value to the first weighted value and the second weighted value and determines the call score (for example, k1=k2=1).

Contrarily, if the remote server 2 receives the container stacking information, “urgent”, the remote server 2 determines that the collection is urgent. Accordingly, the remote server 2 applies a higher value than the general value to the first weighted value as the weighted value for the distance and applies a lower value than the general value to the second weighted value as the weighted value for the service charge and determines the call score (for example, k1=2 and k2=0.5).

In the case of the container stacking information, “urgent”, according to the present invention, the collection company 3 closer to the container return apparatus 100 is called even though the service charge of the corresponding collection company 3 is relatively high, so that the containers stacking in the container return apparatus 100 can be more quickly collected.

Under the container collection system as shown in FIG. 14, the used multi-use or single-use containers automatically stack in the container return apparatus 100, are discharged from the container return apparatus 100, and are washed and recycled through the collection company 3, so that the collection and recycling of the multi-use or single-use containers can be more conveniently achieved through the automated system.

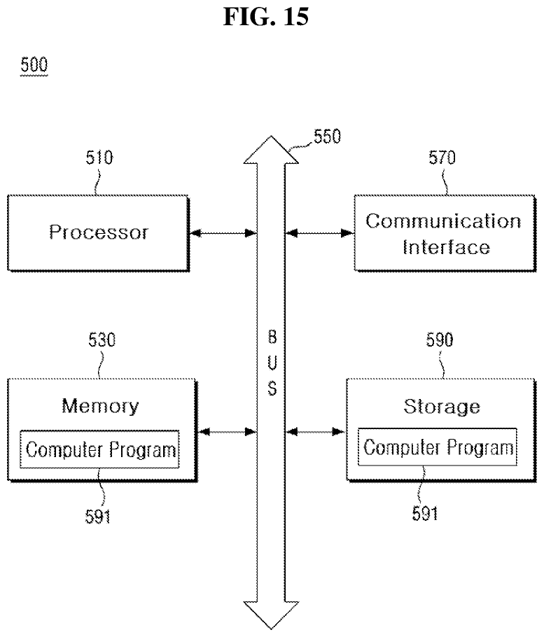

Hereinafter, an exemplary computing device 500 that can implement an apparatus and a system, according to various embodiments of the present invention, will be described with reference to FIG. 15. For example, the computing device 500 may be the container return apparatus 100, or control unit controlling operations of the container return apparatus 100 depicted in FIG. 1.

FIG. 15 is an example hardware diagram illustrating a computing device 500.

As shown in FIG. 15, the computing device 500 may include one or more processors 510, a bus 550, a communication interface 570, a memory 530, which loads a computer program 591 executed by the processors 510, and a storage 590 for storing the computer program 591. However, FIG. 15 illustrates only the components related to the embodiment of the present invention. Therefore, it will be appreciated by those skilled in the art that the present invention may further include other general purpose components in addition to the components shown in FIG. 15.

The processor 510 controls overall operations of each component of the computing device 500. The processor 510 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 510 may perform calculations on at least one application or program for executing a method/operation according to various embodiments of the present invention. The computing device 500 may have one or more processors.

The memory 530 stores various data, instructions and/or information. The memory 530 may load one or more programs 591 from the storage 590 to execute methods/operations according to various embodiments of the present invention. An example of the memory 530 may be a RAM, but is not limited thereto.

The bus 550 provides communication between components of the computing device 500. The bus 550 may be implemented as various types of bus such as an address bus, a data bus and a control bus.

The communication interface 570 supports wired and wireless internet communication of the computing device 500. The communication interface 570 may support various communication methods other than internet communication. To this end, the communication interface 570 may be configured to comprise a communication module well known in the art of the present invention.

The storage 590 can non-temporarily store one or more computer programs 591. The storage 590 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 591 may include one or more instructions, on which the methods/operations according to various embodiments of the present invention are implemented. When the computer program 591 is loaded on the memory 530, the processor 510 may perform the methods/operations in accordance with various embodiments of the present invention by executing the one or more instructions.

Although the operations are shown in a specific order in the drawings, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation. The scope of protection of the present invention should be interpreted by the following claims, and all technical ideas within the scope equivalent thereto should be construed as being included in the scope of the technical idea defined by the present invention.

What is claimed is:

1. A container return apparatus comprising:
an insertion part for inserting a container thereinto;
a checking part for sensing the container inserted to detect a state of the container;
a controller for ejecting the container in a predetermined direction based on the detected state of the container; and
a stacking part for stacking the ejected container on top of another ejected container.

2. The container return apparatus according to claim 1, wherein the insertion part comprises:
a door slidably moving in a first direction or in a second direction opposite to the first direction, by means of a first motor; and
a frame for guiding the sliding movements of the door.

3. The container return apparatus according to claim 2, wherein the insertion part further comprises a first sensor for sensing whether a user's hand enters the insertion part in a state where the door slides in the first direction.

4. The container return apparatus according to claim 2, wherein if an electric current flowing to the first motor is over a threshold value, while the door is sliding in the second direction, the controller stops sliding of the door or allows the door to slide in the first direction.

5. The container return apparatus according to claim 1, wherein the checking part comprises:
a stand on which the container is mounted;
a second sensor for sensing whether the container is mounted on the stand; and
a checking module for detecting the state of the container placed on the stand.

6. The container return apparatus according to claim 5, wherein if the container placed on the stand is sensed by the second sensor, when the door slides in the first direction, the door slides in the second direction.

7. The container return apparatus according to claim 5, wherein the checking module comprises:
a camera for photographing the container placed on the stand or performing image scanning for the container placed on the stand; and
a lighting device for providing light for photographing or image scanning of the camera.

8. The container return apparatus according to claim 5, wherein the controller controls a second motor to allow the stand to move in a third direction when the detected state of the container is at a first state, and the container is ejected in the predetermined direction through an ejection hole exposed to the outside if the stand moves in the third direction.

9. The container return apparatus according to claim 8, further comprising a hook member adapted to enter top of the container by means of the operation of the second motor for moving the stand in the third direction and thus to limit transverse movements of the container.

10. The container return apparatus according to claim 5, wherein the checking part further comprises a third sensor for measuring a container stacking level of a first stacking member of the stacking part, and the first stacking member is located at a position where the container is stackingly placed when the container is ejected.

11. The container return apparatus according to claim 5, wherein the checking part further comprises a fourth sensor for detecting whether the container is ejected in the predetermined direction, and the controller counts the number of containers stacking in the stacking part based on the sensed result of the fourth sensor.

12. The container return apparatus according to claim 1, wherein the stacking part comprises a plurality of stacking members defined as stacking spaces separated from one another, and the plurality of stacking members are changed in position based on the container stacking level of at least one stacking member of the plurality of stacking members.

13. The container return apparatus according to claim 12, wherein the stacking part further comprises a base plate for placing the plurality of stacking members thereon in a circumferential direction around the center thereof, and the base plate rotates by a predetermined angle based on the container stacking level of at least one stacking member of the plurality of stacking members.

14. The container return apparatus according to claim 12, further comprising a loading part for mounting the stacking part thereon and changing the plurality of stacking members in position, the stacking part further comprising a plurality of position detection members located correspondingly to the plurality of stacking members, the loading part comprising a proximity sensor for detecting whether the plurality of position detection members are close thereto, and the controller allowing the plurality of stacking members to be arranged in position based on the sensed signal of the proximity sensor.

15. The container return apparatus according to claim 14, further comprising:
a bottom plate; and
guide rails fixed to the bottom plate,
the loading part being movably coupled to the bottom plate by means of the guide rails, the bottom plate having fixing members for fixing the loading part thereto, and the loading part having coupling members fastened to the fixing members.

16. The container return apparatus according to claim 15, wherein the fixing members are a ball catcher and a door switch.

17. The container return apparatus according to claim 15, wherein if the coupling members are not fastened to the fixing members, the controller outputs a predetermined warning sound through a speaker.

18. A method for operating a container return apparatus, which is executed by a computing device, comprising the steps of:
slidably moving a door in a first direction to open an insertion part;
if a container inserted through the insertion part is sensed, slidably moving the door in a second direction in response to the sensed result for the container to thus close the insertion part;
detecting a state of the container; and
if it is detected that the container is at a first state, operating a motor to allow the container to be ejected in a predetermined direction and located stackingly in a stacking part.
